(19) United States
(12) Patent Application Publication
(10) Pub. No.: US 2006/0267390 A1
(43) Pub. Date: Nov. 30, 2006

(54) Arrangement for a seat for an automobile vehicle to limit its overall lengthwise size

(76) Inventor: David Epaud, Cerny (FR)

Correspondence Address: BACHMAN & LAPOINTE, P.C., 900 CHAPEL STREET, SUITE 1201, NEW HAVEN, CT, 06510, US

(21) Appl. No.: 11/436,469

(22) Filed: May 18, 2006

(30) Foreign Application Priority Data
May 18, 2005 (FR) 0504959

(51) Int. Cl. B60N 2/02

(52) U.S. Cl. 297/313

(57) ABSTRACT

An automobile vehicle seat has a frame capable of being attached to the floor of the vehicle, a backrest connected to the frame and with a backrest surface, a seat pan installed so as to pivot on the frame around a seat pan axis and with a seat pan surface, the seat having an utilisation position in which the backrest is slightly inclined towards the rear, the seat pan surface being more or less horizontal, and a stowage position in which the backrest surface and the seat pan surface are more or less vertical. The backrest is installed so as to pivot on the frame around a backrest axis, the seat including connecting means between the backrest and the seat pan so that the pivoting of the backrest towards the front controls the pivoting of the seat pan in a direction opposite to that of the backrest.

### BACKGROUND OF THE INVENTION

(1) Field of the invention

The present invention relates to a seat for an automobile vehicle with a stowage position in which its overall lengthwise size is limited.

(2) Prior Art

In general, a seat comprises a backrest with a backrest surface and seat pan with seat pan surface, the seat having an utilisation position in which the backrest is slightly inclined towards the rear and the seat pan surface is more or less horizontal. Thus, the user of the seat can sit comfortably being sat on the seat pan surface and with his back bearing against the backrest surface. The aim of the invention is also to modulate the use of the space in the passenger compartment of the vehicle, that is reduce the overall size of a seat when it is not occupied by an user. The space thus freed can then be used for example to load objects into the vehicle. It can also facilitate access to the passenger compartment if the seat is near to a door of the vehicle.

Document EP 1 222 088 proposes to place the seat in a stowage position in which the backrest surface and the seat pan surface are more or less vertical and oriented towards the front. Thus, the backrest and the seat pan are practically stacked one against the other which allows the overall lengthwise size of the seat to be reduced and frees spaces at the rear of the seat. For this, the seat comprises a framework capable of being attached to the floor of the vehicle. The seat pan is installed so as to pivot on the framework. The backrest is installed on the framework by means of a set of two parallel links. A lock allows it to be attached to the floor. A mechanism also connects the backrest and the seat pan. To place the seat in a stowage position, the backrest is pushed forwards so that it is raised and the seat pan pivots forwards.

However, the manoeuvring of such a seat requires the raising of the complete backrest which requires a certain force on account of the weight of the backrest. Also, as the backrest is raised in the stowage position, there is a risk that the top of the backrest will limit the visibility towards the rear inside the passenger compartment. There is also a risk of collision of a lateral edge of the backrest with a lateral wall of the passenger compartment, the upper part of which curves in towards the interior.

### SUMMARY OF THE INVENTION

The aim of the present invention is to provide a seat with a stowage position in which the backrest surface and the seat pan surface are more or less vertical and the overall size of which is limited lengthwise and heightwise in the vehicle. The aim of the invention is also to provide a seat easy to handle when the position of the seat is to be modified.

With these targets in mind, the object of the invention is an automobile vehicle seat including a frame capable of being attached to the floor of a vehicle and a seat pan installed so as to pivot on the frame around a transverse seat pan axis. The seat has an utilisation position in which it is capable of accommodating an user sat on the seat pan and with his back against the backrest, the backrest being slightly inclined towards the rear and a stowage position in which the backrest and the seat pan are more or less vertical. The backrest is installed so as to pivot on the frame around an axis of the backrest, the seat including connecting means between the backrest and the seat pan so that the pivoting of the backrest towards the front controls the pivoting of the seat pan in a direction opposite to that of the backrest.

The front of the seat means the direction in which an user normally sat on the seat would be looking. The pivoting of the backrest towards the front is a seat straightening movement which allows the overall size of the seat to be reduced at the rear of the seat. The pivoting of the seat pan in the opposite direction allows the seat pan to be brought close to the backrest and to take up less space at the front of the seat. The total overall size of the seat is therefore reduced lengthwise. Also, this movement is obtained by an user who can remain standing beside the seat and who manoeuvres only the backrest by a simple movement.

In a specific manner, the connecting means comprise an arm attached to the backrest extending under the pivoting axis of the backrest and at least one link installed so as to pivot on the arm and on the seat pan. The pivoting of the backrest towards the front pivots the arm towards the rear. Thus, the link is driven towards the rear and this exerts a pulling force on the seat pan to make it pivot towards the rear.

According to an improvement, the backrest comprises coupling means to securely attach on request the backrest and the arm. The backrest can then pivot independently of the seat pan. This thus gives for example a table position for the seat in which the backrest is folded down over the seat pan and leaves its rear face exposed on the top of the seat.

The axis of the seat pan is located for example at the rear of the seat pan. After pivoting, in the stowage position, the seat pan is thus in the immediate vicinity of the backrest.

According to a specific arrangement, the frame is installed so as to slide towards the front or towards the rear by means of sliding means. Once in stowage position, the seat can be moved into the position which least hinders the use of the space inside the vehicle. For example, the seat, in stowage position, can be placed against another seat placed in front of it by sliding it forwards. The sliding means also allow adjustment of the position of the seat to be obtained in utilisation position. The sliding means are for example slides attached to the floor of the vehicle or tracks incorporated into the floor in which rollers installed on the frame roll.

According to an improvement, the seat comprises at least one knuckle joint, the knuckle joint including a front link installed so as to pivot on the seat pan around a front axis, and a lower link installed so as to pivot on the frame around a lower axis, the front link and the lower link being articulated in relation to each other, the front link bearing on a support when the seat is in utilisation position. The knuckle joint allows the stiffness of the bearing of the seat to be reinforced by providing the front link transmitting the load of the seat pan to the support. In addition, the knuckle joint extends along the seat pan when the seat is in stowage position. The overall size in stowage position is therefore not significantly increased.

In a specific manner, the support is attached to the frame. Irrespective of the position of the seat, the bearing of the front link is always at the same location on the support. It is therefore possible to provide for a specific configuration at this location.

For example, the support can comprise locking means to connect on request the knuckle joint to the frame.

### BRIEF DESCRIPTION OF THE DRAWINGS

The invention will be better understood and other features and advantages will become apparent on reading the following description. The description refers to the accompanying drawings, in which:

FIG. 1 is a side view of a seat in compliance with the invention, in an utilisation position;

FIG. 2 is a view similar to FIG. 1, the seat being in stowage position;

FIG. 3 is a view similar to FIG. 1, the seat being in an intermediary position.

### DETAILED DESCRIPTION OF THE PREFERRED EMBODIMENT(S)

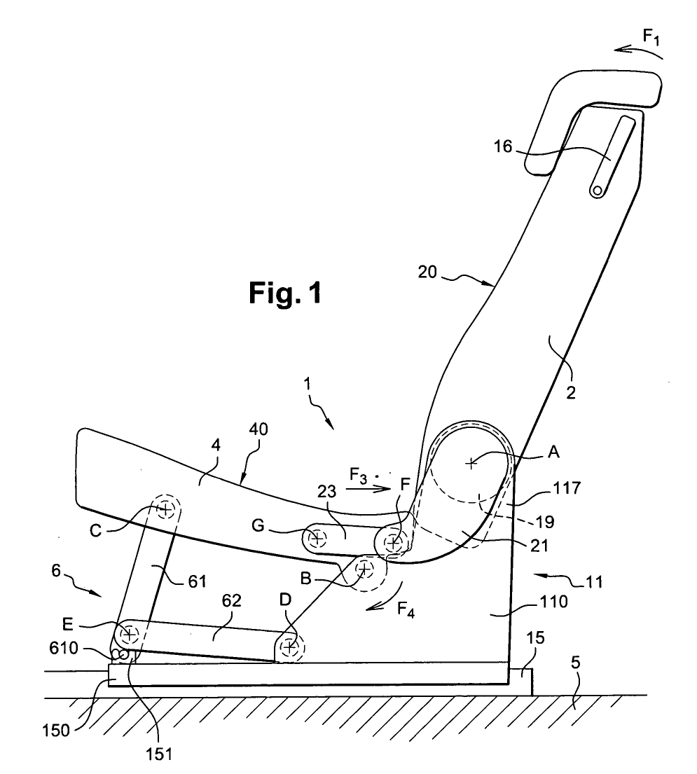

An embodiment of a seat 1 in compliance with the invention is shown on FIGS. 1 to 3. The seat 1 comprises a backrest 2 and a seat pan 4 attached to a frame 11. The seat 1 has an utilisation position, shown on FIG. 1, in which it is capable of accommodating an user sat on a seat pan surface 40 of the seat pan 4 and with his back against a backrest surface 20. For this, the backrest 2 is also inclined towards the rear. The front of the seat 1 is defined as being the direction in which the user looks when normally sat on the seat 1. The frame 11 is connected to the floor 5 of the vehicle by means of slides 15 attached to the floor 5. The longitudinal position of the seat in the vehicle is adjustable by a translation movement of the frame 11 in the slides 15, in a known manner.

The frame 11 comprises two side flanges 110 attached by crossmembers, not shown. Each flange 110 comprises an upper arm 117 extending at the rear of the seat and upwards. The backrest 2 is installed so as to pivot around a transverse backrest axis A between the upper arms 117 of the flanges 110. The seat 1 also comprises articulation means 19 to attach on request the backrest 2 to the frame 11, in a known manner.

The seat pan 4 is installed so as to pivot on the frame 11 around a seat pan axis B placed under and at the rear of the seat pan. The front of the seat pan 4 is held by two knuckle joints 6 placed symmetrically on each side of the seat 1. Each knuckle joint 6 comprises a front link 61 and a lower link 62. The front link 61 is installed so as to pivot on the seat pan 4 at the front of the seat pan around a front axis C. The lower link 62 is installed so as to pivot on the frame 11 around a lower axis D. The links 61, 62 are articulated in relation to each other around a knuckle joint axis E.

The slides 15 each comprise a support 150 extending towards the front of the frame 11. At least one of the supports 150 comprises a lock 151 intended to mate with a pin 610 attached to the front link 61 to lock the link onto the support.

The seat 1 also comprises connecting means between the backrest 2 and the seat pan 4. The connecting means comprise an arm 21 extending downwards from the backrest along the upper arm 117 of the one of the flanges 110, below the axis of the backrest. A control link 23 is installed so as to pivot at a lower end 221 of the arm 22 around a first link axis F and on the seat pan 4 around a second link axis G. The control link 23 extends more or less horizontally above the seat pan axis B when the seat is in utilisation position.

Control means comprise an operating handle 16 installed so as to pivot on top of the backrest 2, a control cable attaching the operating handle 16 to the locks 151 and a connecting cable to the articulation means 19. The control and connecting cables are not shown.

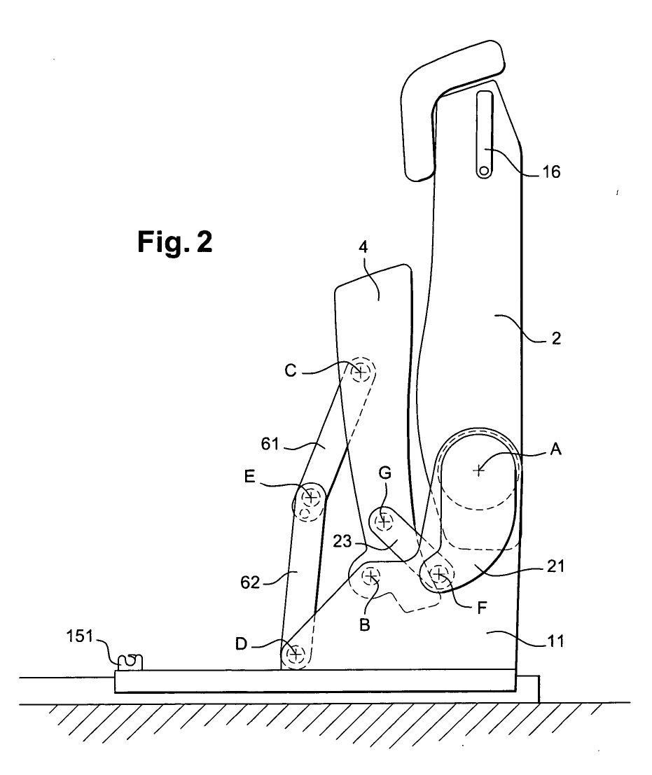

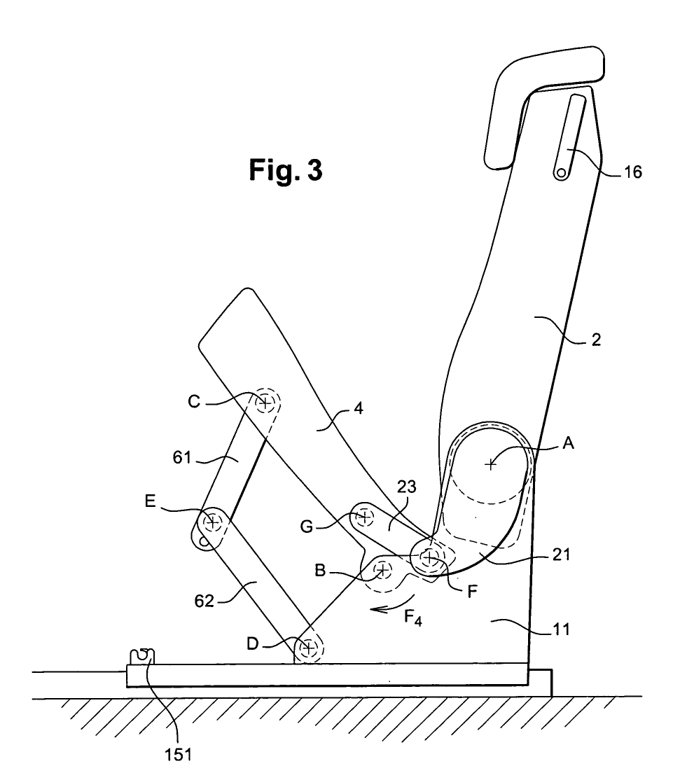

The operation of the seat 1 according to the invention will be described in relation to FIGS. 1 to 3. The utilisation position, as described previously, is shown on FIG. 1. When the user wishes to place the seat 1 in stowage position, he pivots the operating handle 16 in the direction shown by arrow F1 until the pins 610 are freed by the locks 151 and the articulation means 1-9 are actuated to unlock the backrest 2 in relation to the frame 11. The user can then cause the backrest 2 to pivot around the backrest axis A, also in the direction shown by arrow F1. The arms 21 are driven in the same pivoting movement. The arms 21 pull on the seat pan 4 in the direction shown by arrow F3 by means of the control link 23 and cause the seat pan 13 to pivot around the seat pan axis B in the direction shown by arrow F4, as shown on FIG. 3, to the stowage position, as shown on FIG. 2. When the operating handle 16 is released, the backrest 2 is again locked by the articulation means 19, in a more or less vertical position. At the same time, the links 61, 62 of the knuckle joints align and extend along the seat pan 4.

It can be seen that, in this stowage position, the overall lengthwise size of the seat 1 is more or less that of the frame 11 and that the increase in the overall heightwise size of the seat is due only to the straightening of the backrest 2. To return to the utilisation position, the articulation means 19 are again unlocked with the operating handle 16, the backrest 2 is pivoted towards the rear in the direction opposite to the one shown by arrow F1 to the utilisation position. The seat pan 4 then returns to the utilisation position. Then, after the operating handle 16 has been released, locking of the pins 610 is obtained in the locks 151.

The invention is not limited to the embodiment described above only as an example. The arm could, for example, be freed from the backrest to allow the backrest to be folded down alone against the seat pan. For this, a transverse pin installed so as to slide in the backrest will be provided to mate with the arm 21 and, according to its position, couple or not the arm and the backrest.

1. Automobile vehicle seat including a frame capable of being attached to a floor of a vehicle and a seat pan installed so as to pivot on the frame around a transverse seat pan axis, the seat having a utilisation position in which the seat is capable of accommodating a user sitting on the seat pan and with a back of the user bearing against a backrest, the backrest being slightly inclined towards a rear of the vehicle and a stowage position in which the backrest and the seat pan are more or less vertical, the backrest being installed so as to pivot on the frame around a backrest axis, the seat including connecting means between the backrest and the seat pan so that pivoting of the backrest towards a front of the vehicle controls pivoting of the seat pan in a direction opposite to that of the backrest.

2. The automobile vehicle seat in accordance with claim 1, wherein the connecting means comprise an arm attached to the backrest extending below the pivoting axis of the backrest and at least one link installed so as to pivot on the arm and on the seat pan.

3. The automobile vehicle seat in accordance with claim 2, wherein the backrest comprises coupling means for attaching together, on request, the backrest and the arm.

4. The automobile vehicle seat in accordance with claim 1, wherein the seat pan axis is located at the rear of the seat pan.

5. The automobile vehicle seat in accordance with claim 1, wherein the frame is installed so as to slide towards the front or the rear by means of sliding means.

6. The automobile vehicle seat in accordance with claim 1, further comprising at least one knuckle joint, the at least one knuckle joint including a front link installed so as to pivot on the seat pan around a front axis and a lower link installed so as to pivot on the frame around a lower axis, the front link and the lower link being articulated in relation to each other, and the front link bearing on a support when the seat is in the utilisation position.

7. The automobile vehicle seat in accordance with claim 6, wherein the support is attached to the frame.

8. The automobile vehicle seat in accordance with claim 7, wherein the support comprises locking means for attaching, on request, the knuckle joint to the frame.
